(19) United States
(12) Patent Application Publication
(10) Pub. No.: US 2010/0190368 A1
(43) Pub. Date: Jul. 29, 2010

(54) SAFETY DEVICE FOR HOUSEHOLD OVENS

(75) Inventors: Keld Christensen, Fredericia (DK); Henry Yndgaard Sorensen, Brenderup (DK)

Correspondence Address: PEARNE & GORDON LLP, 1801 EAST 9TH STREET, SUITE 1200, CLEVELAND, OH, 44114-3108, US

(73) Assignee: Electrolux Home Products Corporation N.V., Zaventem (BE)

(21) Appl. No.: 12/517,444

(22) PCT Filed: Dec. 10, 2007
(86) PCT No.: PCT/DK2007/000536

§ 371 Date: Apr. 5, 2010

(30) Foreign Application Priority Data
Dec. 8, 2006 (EP) 06 025 491.9

(51) Int. Cl. H01R 13/703

(52) U.S. Cl. 439/188

(57) ABSTRACT

In a cooker it is undesirable that a given power outlet (1) and a given heating element (5) are energized at the same time. Instead of letting power supplied to the heating element (5) switch off the power outlet, the insertion of a plug (3) in the power outlet is used to switch off the heating element (5).

The invention relates to a device for ensuring that a heating element and a power outlet socket in a domestic cooker are not energized at the same time.

In a kitchen installation a free-standing cooker or an electrical oven may be provided with an electrical outlet or socket for use with small appliances that are needed in the working area of the cooker. An electrical outlet may in certain building projects be provided in the wall prior to installation of the oven, but in many cases it is practical to provide an electrical outlet in a part of the oven enclosure, because the oven as such is already supplied with power, and a separate installation in the wall would seem superfluous and even expensive to establish.

A radiative heating element is frequently provided inside the cavity near its ceiling to obtain grilling of food below it, but the element will also heat the surroundings of the cavity, in particular near the top, above the door. If a power outlet is placed here, it may be heated to such a degree that a plug fitted in it is unpleasant to the touch and the small appliance that is provided with energy may not be removed as quickly as desired. A thermal protection in the form of a glove or cloth may be needed, and this slows down the process of removing the plug. If the plug remains for a prolonged period of time it may suffer thermal overload, because the plug of a small appliance need not be manufactured in heat tolerant materials to the same degree as for instance an oven. Both of these aspects constitute a safety risk.

One simple solution to this problem is to prevent power supply to the outlet or socket when the heating element is energized. In that case there would be no reason to try to use the socket, because it does not work. This is a solution that is simple to implement in connection with the built-in oven control devices.

However, analysis of normal work in a kitchen has shown that this solution is an irritant, because it becomes impossible to know when a heating element that may be controlled by a thermostat is actually functioning and hence disconnect the socket from the electrical power. To the user the function appears erratic.

In GB 1 445 055 A1 a circuit is described in which it is demonstrated how to switch on a primary circuit for a transformer when a plug is inserted in the corresponding secondary circuit. Other well-known solutions using the plugging-in as a control comprise the disconnection of an internal battery in an apparatus when the plug from an external power supply is inserted into the apparatus.

According to the invention a much better solution has been found, which is particular in that the presence of a plug in the socket is detected by predefined means, which means disconnect the heat generating element from its power supply. In this manner, the work with the small appliance may continue for as long as it is needed, and it may be safely disconnected by pulling the plug from the socket, and subsequently the heat generating element may resume its function, if it were switched on prior to the insertion of the plug, alternatively it may now be switched on—and perform heating—as a conscious operation. In other words, the means re-connect the energy transferring element when the plug is again removed from the socket.

According to advantageous embodiments of the invention, the means for detecting the presence of a plug may be mechanical or e.g. magnetical, while optical detection cannot be ruled out if the the heat generating element is controlled electronically.

The mechanical detection of the presence of a plug may be a pin projecting through the bottom of the socket, said pin being pushed in by the plug upon insertion, and the new position of the pin may cause a disconnecting by means of a switch.

The invention is advantageous with all types of heat generating elements, such as radiative resistance elements, a microwave generator with suitable antenna means, or induction coil supplying generators.

According to an advantageous embodiment of the invention, the mechanical means is constituted by a child-safety device already provided in the power outlet socket, said child-safety device being provided with an element adapted to engage a two-position snap-action switch in order to disconnect a power supply wire to the heating element.

There are two basic principles of child-safety devices, both of which rely on the need for both prongs of a plug (or the ground prong in e.g. the case of United Kingdom installations) to act simultaneously on an element provided with oblique surfaces. The oblique surfaces serve to provide both a movement towards the inside of the plug mechanism, freeing the element and to provide a movement that opens the hole for the prong. One principle is used in the form of a slider that moves in a linear fashion after having been freed from engagement with the bottom of the socket in the course of the pushing action of the plug, and the other undertakes a rotary movement. In the former case, the plunger of a snap-action switch may be simply placed adjacent to the slider, so that the switching-off occurs when the slider is moving sideways. In the latter case, the rotary movement of the element may be transmitted by a projection or pin to reach the snap-action switch. The projection or pin, but also the slider element itself may be termed a switch actuator.

Simple modifications on the described inventive concept are imaginable. Although the contacts of a snap-action switch, even a micro-switch, are capable of carrying the full current of the heater element, because no inductive current is involved in breaking, the snap-action switch may be used to carry only the current for a relay controlling the heater current. This would be the case if an electronic control centre were used for the control of cooker operation. Such a relay would either be electromechanical or electronic in the form of for instance a power-FET component.

The invention furthermore relates to a use of the constructions described above and defined by the claims.

The invention will be described in greater detail in the following with reference to the drawing, in which

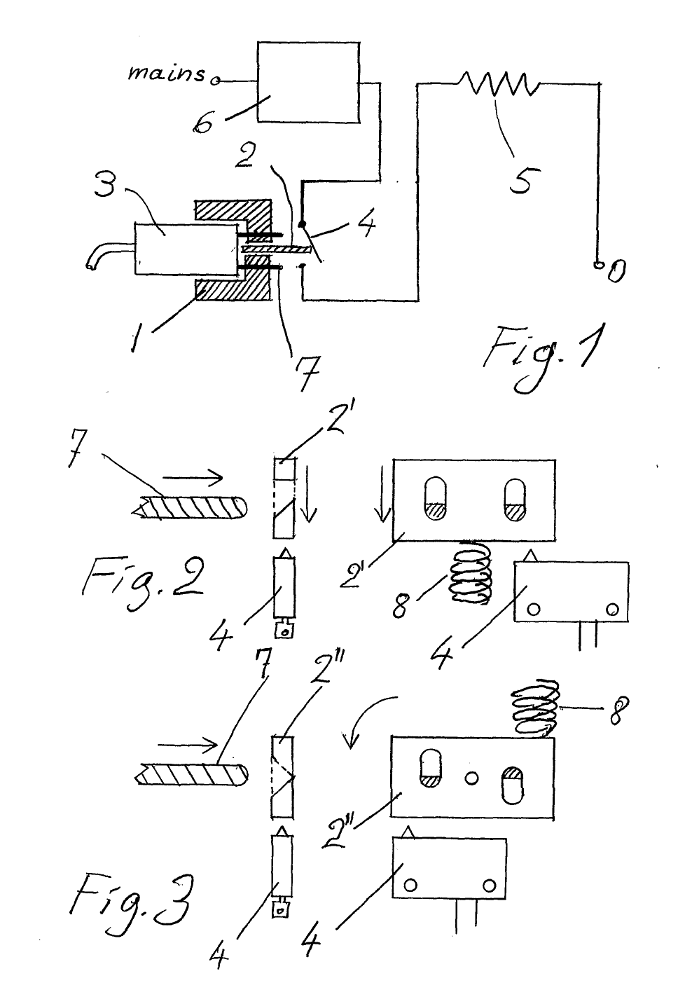

FIG. 1 is a simplified circuit diagram showing the principle of the device according to the invention,

FIG. 2 is a simplified drawing of the mechanical elements for one embodiment of the invention,

FIG. 3 is a simplified drawing of the mechanical elements for a different embodiment of the invention.

In FIG. 1 is seen a schematic representation of a socket 1, in which a pin 2 is forced by a plug 3 to recede into the body of the socket. The other end of the pin 2 opens a switch 4 that may carry the current that supplies a heater 5. The current for the heater 5 makes a “detour” to the switch 4, and it is otherwise controlled by a control unit 6 that contains a switch and/or a thermostat. The prongs of the plug 3 are shown at 7, but the power supply to the socket 1 is not shown, because it is immaterial for the invention, and it may be at a different mains voltage than the voltage used for the heating element. Furthermore, power is at all times available from this outlet, unless it is fitted with a separate manual switch. The moment the plug 3 is extracted from the socket 1, the normal controls 6 for the heating element 5 are completely functional.

In FIG. 2 is shown an element that is otherwise known from a child safety device, i.e. a slider 2′ that is able to act on a switch 4 when it is pushed downwards (in the drawing) when a prong 7 from a plug is inserted. To the left the elements of the heating element disconnecting device are shown from the side, and to the right as seen from the opening of the socket. A compression spring 8 is provided to maintain the holes for the prongs shut, unless they are both inserted at the same time. The moment the plug is extracted from the socket, the normal controls for the heating element are completely functional.

In FIG. 3 is shown a similar element 2″ to that shown at 2′ in FIG. 2. This element is disposed to rotation when both prongs 7 of a plug are inserted. To the left the elements of the heating element disconnecting device are shown from the side, and to the right as seen from the opening of the socket. A compression spring 8 is provided to maintain the holes for the prongs shut, unless they are both inserted at the same time. When the rotation is obtained the switch 4 is actuated. The moment the plug is extracted from the socket, the normal controls for the heating element are completely functional.

Summing up, in a cooker it may be undesirable that a given power outlet and a given heating element are energized at the same time. Instead of letting power supplied to the heat generating element switch off the power outlet, the insertion of a plug in the power outlet is used to switch off the heat generating element.

The invention has been described in some detail above, but this is not limiting per se, as the skilled person will be able to devise additional solutions that perform in an equivalent manner, thereby obtaining similar advantageous results.

The foregoing description of the specific embodiments will so fully reveal the general nature of the present invention that others skilled in the art can, by applying current knowledge, readily modify or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of forms without departing from the invention.

Thus, the expressions “means to . . . ” and “means for . . . ”, or any method step language, as may be found in the specification above and/or in the claims below, followed by a functional statement, are intended to define and cover whatever structural, physical, chemical, or electrical element or structure, or whatever method step, which may now or in the future exist which carries out the recited functions, whether or not precisely equivalent to the embodiment or embodiments disclosed in the specification above, i.e., other means or steps for carrying out the same function can be used; and it is intended that such expressions be given their broadest interpretation.

1. A device for preventing overload of an electrical power supply by a domestic cooker comprising a built-in energy transferring element (5) for heating purposes and a built-in power outlet socket (1), characterized in that the presence of a plug (3) in said socket is detected by means (2), which means cause electrical disconnection of the energy transferring element (5) from its power supply.

2. A device according to claim 1, characterized in that said means (2) are mechanical means.

3. A device according to claim 1, characterized in that said means (2) are magnetic means.

4. A device according to claim 1, characterized in that said energy transferring element (5) is constituted by a radiative resistance element.

5. A device according to claim 1, characterized in that said energy transferring element (5) is constituted by a microwave generator.

6. A device according to claim 1, characterized in that said energy transferring element (5) is constituted by an induction heating generator.

7. A device according to claim 1, characterized in that said means (2) control electronic switching means for disconnecting the energy transferring element (5) from its power supply when said plug (3) is detected and re-connects the energy transferring element (5) when said plug (3) is again removed from said socket (1).

8. A device according to claim 2, characterized in that said mechanical means is constituted by a child-safety device (2′, 2″) already provided in the power outlet socket, said child-safety device being provided with an element adapted to engage a two-position snap-action switch (4) in order to disconnect a power supply wire to the energy transferring element (5).

9. Use of a device according to claim 1, comprising switching on an oven, plugging in a plug fitted into the oven cabinet for providing power to a kitchen appliance, permitting the oven to remain without power, using said kitchen appliance for its intended purpose in proximity to the oven, followed by unplugging said kitchen appliance, thereby restoring power to the oven for its heating.
